(19) United States
(12) Patent Application Publication
(10) Pub. No.: US 2014/0195443 A1
(43) Pub. Date: Jul. 10, 2014

(54) SYSTEM FOR CONVERGENCE INDEX SERVICE

(71) Applicants: Nak Kyu Lee, Incheon (KR); Hye Jin Lee, Incheon (KR); Jung Han Song, Uiwang-si (KR); Jeanho Park, Ansan-si (KR); Sung Min Bae, Seoul (KR); Hyoung Wook Lee, Chungju-si (KR); Chul Young Kim, Seoul (KR)

(72) Inventors: Nak Kyu Lee, Incheon (KR); Hye Jin Lee, Incheon (KR); Jung Han Song, Uiwang-si (KR); Jeanho Park, Ansan-si (KR); Sung Min Bae, Seoul (KR); Hyoung Wook Lee, Chungju-si (KR); Chul Young Kim, Seoul (KR)

(73) Assignee: Korea Institute of Industrial Technology, Cheonan-si, Chungcheongnam-do (KR)

(21) Appl. No.: 14/116,060

(22) PCT Filed: Dec. 30, 2011
(86) PCT No.: PCT/KR2011/010393

§ 371 Date: Feb. 10, 2014

(30) Foreign Application Priority Data
May 9, 2011 (KR) 10-2011-0043317

(51) Int. Cl. G06Q 50/18; G06Q 10/00

(52) U.S. Cl. CPC G06Q 50/184; G06Q 10/00
USPC 705/310

(57) ABSTRACT

The present invention relates to a system for servicing convergence index, and more particularly, to a system for servicing a convergence index for outputting a convergence index by utilizing patent information and servicing same. According to the system for servicing the convergence index of the present invention, the convergence index can be outputted by using time information related to a patent which is included in a patent group, a patent classification, and an industrial classification that corresponds to the patent classification. The system for servicing the convergence index of the present invention systematically outputs the convergence index by using patent data, which is an objective data, thereby outputting the convergence index which is objective and appropriate.

### CROSS-REFERENCE TO RELATED APPLICATIONS

This application is a national stage of International Application No. PCT/KR2011/010393, filed Dec. 30, 2011, which claims the benefit of Korean Application No. 10-2011-0043317, filed May 9, 2011, in the Korean Intellectual Property Office. All disclosures of the document(s) named above are incorporated herein by reference.

### BACKGROUND OF THE INVENTION

1. Field of the Invention

The present invention relates to a system for servicing a convergence index, and more particularly, to a system for servicing convergence index for calculating a convergence index utilizing patent information and servicing the same.

2. Description of the Related Art

With the start of the 21st century, convergence between homogeneous and heterogeneous fields such as technology and technology, product and service, service and service, or the like over all industrial areas has accelerated. The term “convergence” has started to be used in such a manner that combination of communication, broadcasting, and media has been predicted by Professor Negroponte of MIT and the predicted combination has been examined in academia.

For example, over the course of the 1990s, all industrial areas developed into IT convergence in which IT is combined.

With the start of the 21st century, the United States, the EU, Japan, and the like have expanded R&D and investment with respect to convergence technologies, and various types of convergence have exponentially increased. The United States set convergence of bio technologies, information technologies, and cognitive science based on nano technologies as the national agenda, and the EU aims for convergence of a wide range of disciplines and technologies as well as convergence of nano, bio, information, and cognitive (NBIC) technologies.

In this manner, convergence has been established as the global agenda in the world, and in Korea, according to such global trends, the “Industrial Convergence Promotion Act” was passed in the National Assembly on April 2011, and became effective in October 2011.

However, despite such trends of convergence, a clear and highly valid convergence index which quantifies the degree of convergence has not been developed, and therefore there are urgent needs to develop an objective and reasonable convergence index.

### SUMMARY OF THE INVENTION

### Technical Problem to be Solved

The present invention is directed to a system for servicing a convergence index that calculates an objective convergence index utilizing patent data, and services the calculated objective convergence index to a user.

Specifically, the present invention is directed to a system for servicing a convergence index that calculates a capability development index, a capability convergence index, and an industry relation index which constitute a convergence index.

### Technical Solution

According to an aspect of the present invention, there is provided a convergence index service system for providing a convergence index to a user computer through a wired network or a wireless network, the system including: a patent group receiving unit configured to receive a patent group including at least two patents from the user computer; a data processing unit configured to acquire time information, a patent classification and an industrial classification corresponding to the patent classification related to each of the at least two patents in the patent group; a capability development index calculating unit configured to calculate a capability development index based on the time information and the patent classification acquired by the data processing unit; a capability convergence index calculating unit configured to calculate a capability convergence index based on the patent classification acquired by the data processing unit; and an industry relation index calculating unit configured to calculate an industry relation index based on the patent classification and the industrial classification acquired by the data processing unit, wherein the industry relation index calculating unit calculates the industry relation index using a relation score of heterogeneous industries and a relation score of homogeneous industries calculated based on the patent classification and the industrial classification.

The industry relation index calculating unit may include: an industrial distribution ratio calculating unit configured to calculate an industrial distribution ratio based on the industrial classification; an industrial classification selecting unit configured to select at least two of the industrial classification according to number of patents related to the industrial classification; a technology convergence calculating unit configured to calculate the degree of technology convergence based on the number of patents related to the industrial classification selected by the industrial classification selecting unit; and a heterogeneous industry relation score calculating unit configured to calculate the relation score of heterogeneous industries based on the industrial distribution ratio and the degree of technology convergence.

The industry relation index calculating unit may include: an industrial classification selecting unit configured to select at least two of the industrial classification according to number of patents related to the industrial classification; a technological distribution ratio calculating unit configured to calculate a technological distribution ratio based on the number of patents related to the industrial classification selected by the industrial classification selecting unit; a technological occupation ratio calculating unit configured to calculate a technological occupation ratio based on number of patent classification including the patent related to the industrial classification selected by the industrial classification selecting unit; and a homogeneous industry relation score calculating unit configured to calculate the relation score of homogeneous industries based on the technological distribution ratio and the technological occupation ratio.

The technological occupation ratio calculating unit may include a normalization unit configured to normalize the technological occupation ratio based on a correction coefficient of the technological occupation ratio.

It is possible that the capability development index calculating unit calculates the capability development index using a capability score and a time score calculated based on the time information and the patent classification.

The capability development index calculating unit may include: a patent number calculating unit configured to calculate number of patents per unit time with respect to the patent group based on unit time and the time information a new technology-related patent number calculating unit configured to calculate number of new technology-related patents per unit time based on the patent classification and unit time; and a capability score calculating unit configured to calculate the capability score based on the number of patents per unit time and the number of new technology-related patents per unit time.

The capability development index calculating unit may include: a cumulative patent number calculating unit configured to calculate cumulative number of patents per unit time for the patent group based on unit time and the time information; a cumulative reference time point calculating unit configured to calculate a cumulative reference time point related to the cumulative number of patents per unit time; and a time score calculating unit configured to calculate the time score based on the cumulative reference time point.

It is possible that the capability convergence index calculating unit calculates the capability convergence index using a capability convergence score and a service score calculated based on the patent classification.

The capability convergence index calculating unit may include: a patent classification number calculating unit configured to calculate number of patent classification based on number of at least one patent classification related to a single patent; a patent classification number weight acquiring unit configured to acquire weights of the number of patent classification corresponding to the number of patent classification; and a capability convergence score calculating unit configured to calculate the capability convergence score based on the number of patent classification and the weights of the number of patent classification.

The capability convergence index calculating unit may include: a service classification group transmitting unit configured to transmit a service classification group including at least two services to the user computer; a selection information receiving unit configured to receive selection information including information on the service selected from the service classification group from the user computer; and a service score calculating unit configured to calculate the service score based on the selection information.

It is possible that the patent classification is determined according to a predetermined depth in a patent classification system including the patent classification.

It is possible that the capability development index is calculated based on a main patent classification of the patent classification, the capability convergence index is calculated based on a sub patent classification and the main patent classification, and the industry relation index is calculated based on the main patent classification.

The system may further include a data storage unit configured to store the patent, the patent classification and the industrial classification.

The system may further include an auxiliary variables storage unit configured to store auxiliary variables required for calculating the capability development index, the capability convergence index and the industry relation index.

### Advantageous Effects

The system for servicing the convergence index according to the present invention has the following effects.

First, according to the system for servicing the convergence index according to the present invention, the convergence index is systematically calculated by using patent data, which is objective data, thereby calculating the convergence index which is objective and appropriate.

Second, when utilizing the system for servicing the convergence index according to the present invention, convergence indexes among products, industries, companies, technologies, and the like may be systematically and rapidly calculated.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a structural diagram showing a relationship between a detailed convergence index and a sub element score which are included in a convergence index according to an embodiment of the present invention;

FIG. 2 is a diagram showing a system for servicing a convergence index according to an embodiment of the present invention;

FIG. 3 is a diagram showing an example of a capability development index calculating unit for calculating a capability score according to an embodiment of the present invention;

FIG. 4 is a diagram showing an example of a capability development index calculating unit for calculating a time score according to an embodiment of the present invention;

FIG. 5 is a diagram showing an example of a capability convergence index calculating unit for calculating a capability convergence score according to an embodiment of the present invention;

FIG. 6 is a diagram showing an example of a capability convergence index calculating unit for calculating a service score according to an embodiment of the present invention;

FIG. 7 is a diagram showing an example of an industry relation index calculating unit for calculating a relation score of heterogeneous industries according to an embodiment of the present invention;

FIG. 8 is a diagram showing an example of an industry relation index calculating unit for calculating a relation score of homogeneous industries according to an embodiment of the present invention;

FIG. 9 is a diagram showing an example of a convergence index servicing unit according to an embodiment of the present invention;

FIG. 10 is a graph showing an example of a process for calculating a capability score according to an embodiment of the present invention; and

FIG. 11 is a graph showing an example of a process for calculating a time score according to an embodiment of the present invention.

### DETAILED DESCRIPTION OF THE EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

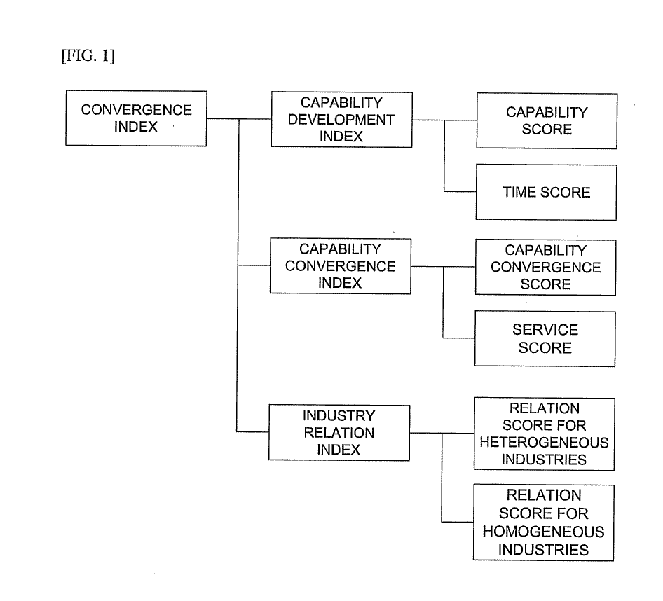

FIG. 1 is a structural diagram showing a relationship between a detailed convergence index and a sub element score which are included in a convergence index according to an embodiment of the present invention.

Referring to FIG. 1, the convergence index includes three detailed convergence indexes such as a capability development index, a capability convergence index, and an industry relation score. In addition, the capability development index is calculated based on a capability score and a time score, the capability convergence index is calculated based on a capability convergence score and a service score, and the industry relation index is calculated based on a relation score of heterogeneous industries and a relation score of homogeneous industries.

Hereinafter, a system 1000 for servicing a convergence index that calculates the three detailed convergence indexes will be described in detail.

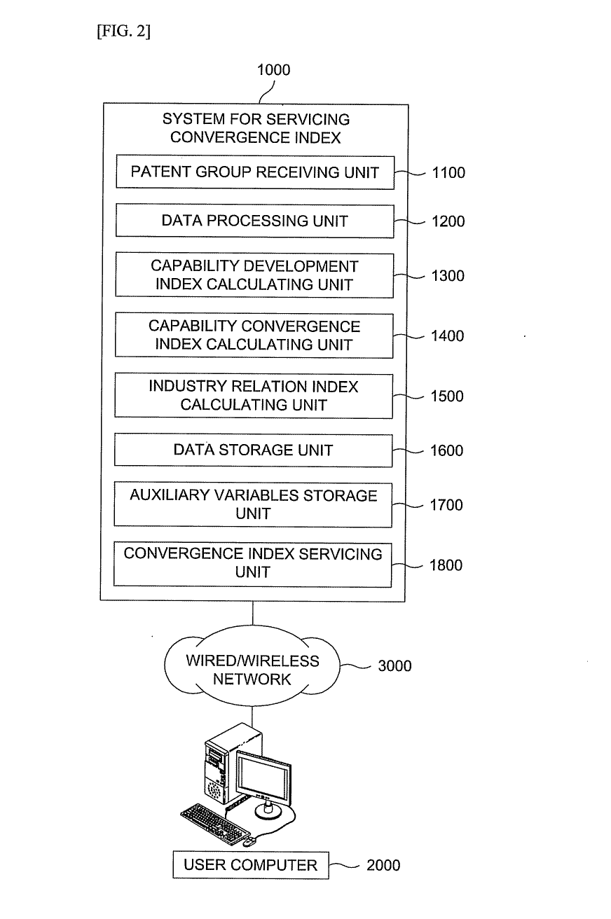

FIG. 2 is a diagram showing a system 1000 for servicing a convergence index according to an embodiment of the present invention.

Referring to FIG. 2, the system 1000 for servicing the convergence index according to an embodiment of the present invention is connected to at least one user computer 2000 through a wired/wireless network 3000. The system 1000 for servicing the convergence index includes a patent group receiving unit 1100, a data processing unit 1200, a capability development index calculating unit 1300, a capability convergence index calculating unit 1400, and an industry relation index calculating unit 1500. In addition, the system 1000 for servicing the convergence index may further include a data storage unit 1600, an auxiliary variables storage unit 1700, and a convergence index servicing unit 1800.

The patent group receiving unit 1100 receives a patent group including at least two patents from the user computer 2000. The patent group may be obtained by removing noise from results searched through a search engine based on search expressions including information about specific products, technologies, applicants, and the like. In addition, the patent group includes only published patents, only registered patents, or a mixture thereof. In the case of the mixture thereof, the same or different weights may be given to the published patents and the registered patents. The patent group receiving unit 1100 may obtain the patent group through search expressions, but obtain the patent group using patent data (patent number and the like) stored in the user computer 2000. Meanwhile, when a user manages a project for calculating a plurality of convergence indexes, the patent group receiving unit may obtain at least one patent group corresponding to the project for each project.

The data processing unit 1200 acquires time information, a patent classification and an industrial classification corresponding to the patent classification related to the patents included in the patent group.

The time information may be a reference date for calculating a convergence index, and include any one of the earliest date, a filing date, a publication date, and a registration date. The time information preferably uses the earliest date or the filing date as the reference date, and for the sake of accuracy, more preferably uses the date considered earliest in the priority claim as the reference date.

The patent classification may use international standard patent classifications such as International Patent Classification (IPC), or national standard patent classifications such as United States Patent Classification (USPC). The patent classification has a depth of the patent classification in accordance with a patent classification system, and when using IPC, a subclass or main group level (depth) is preferably used. In addition, when using USPC, it is preferable that a class or a sub patent classification level of the class be used. The patent classification may use only a main classification, or may use a sub classification together with the main patent classification.

Industrial classification information may be standard industrial classification (SIC) or predetermined industrial classification.

The capability development index calculating unit 1300 calculates a capability development index based on the time information and patent classification which are acquired by the data processing unit 1200. Specifically, the capability development index calculating unit 1300 may calculate the capability development index using a capability score and a time score which are calculated based on the time information and the patent classification.

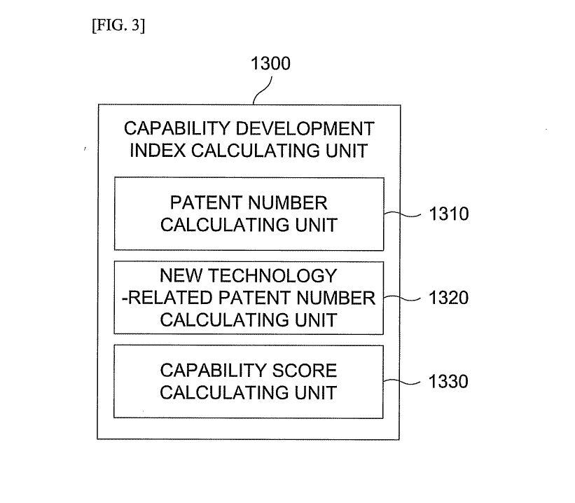

FIG. 3 is a diagram showing an example of a capability development index calculating unit 1300 for calculating a capability score according to an embodiment of the present invention.

Referring to FIG. 3, the capability development index calculating unit 1300 may include a patent number calculating unit 1310, a new technology-related patent number calculating unit 1320, and a capability score calculating unit 1330.

The patent number calculating unit 1310 calculates the number of patents per unit time based on unit time and the time information with respect to the patent group. Specifically, the patent number calculating unit 1310 calculates the number of patents per unit time based on unit time (for example, year) with respect to the patent group including at least two patents.

The new technology-related patent number calculating unit 1320 calculates the number of new technology-related patents per unit time based on the patent classification and unit time. Specifically, in order to calculate the number of new technology-related patents per unit time, when there is no patent based on a predetermined patent classification depth and then a patent appears at a specific time point T, this can be seen as appearance of new technology. For example, when an initial patent appears in a corresponding unit using a USPC class unit or an IPC subclass unit, it can be seen as appearance of new technology at this time.

The capability score calculating unit 1330 calculates the capability score based on the number of patents per unit time and the number of new technology-related patents per unit time. Specifically, the capability score calculating unit 1330 first calculates a new technology score based on the number of patents per unit time and the number of new technology-related patents per unit time.

The following Equation (1) is an example of a method for calculating a new technology score (DFDi) per year.

DFDi=NPi*Wp+NTi*Wt Equation (1)

(DFDi: new technology score in year i, NPi: the number of patents per year, Wp: patent weights, NTi: the number of new technology-related patents, and Wt: technological (classification) weights)

Meanwhile, the new technology score may be calculated using a depreciation coefficient in consideration of technological obsolescence. The depreciation coefficient is obtained by reflecting a reduction in the value of technology over time in consideration of a life cycle of technology. Specifically, the new technology score may be calculated by multiplying the right hand side of Equation (1) by a depreciation coefficient of the corresponding year (depreciation coefficient α≦1).

Next, a technological cumulative score per year is calculated based on the calculated new technology score per year.

The following Equation (2) is an example of a method for calculating a technological cumulative score (CDFDi) per year.

CDFDi=DFD0+DFD1+DFD2+ . . . +DFDi−1+DFDi Equation (2)

(CDFDi: technological cumulative score per year, and DFDi: new technology score in year i)

Next, a capability score (FS) is calculated based on the technological cumulative score (CDFDi) per year.

The following Equation (3) is an example of a method for calculating the capability score (FS).

FS=(CDFDn−CDFDt−1)/(CDFDn) Equation (3)

(FS: capability score, CDFDn: technological cumulative score in entire year n, and CDFDn-CDFDt−1: technological cumulative score after time point t)

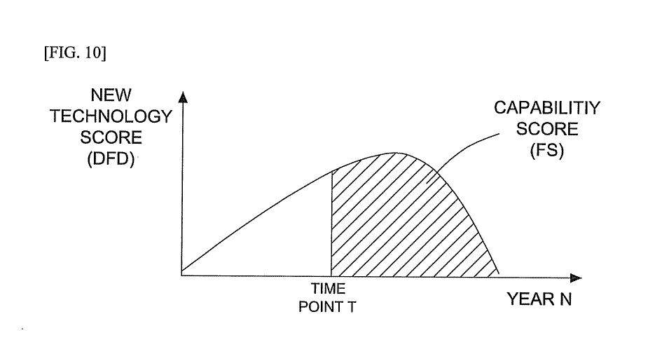

That is, the capability score (FS) may be defined as the ratio of the technological cumulative score (CDFDn-CDFDt−1) after the time point t to the technological cumulative score (CDFDn) in the entire year n as shown in FIG. 10.

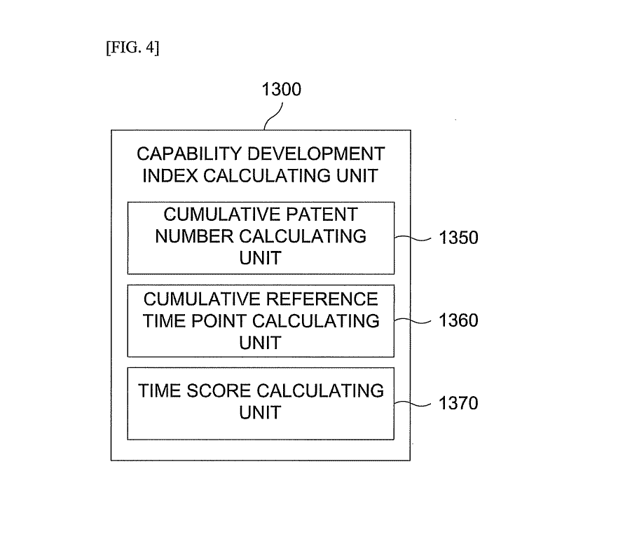

FIG. 4 is a diagram showing an example of the capability development index calculating unit 1300 for calculating a time score according to an embodiment of the present invention.

Referring to FIG. 4, the capability development index calculating unit 1300 may include a cumulative patent number calculating unit 1350, a cumulative reference time point calculating unit 1360, and a time score calculating unit 1370.

The cumulative patent number calculating unit 1350 calculates the cumulative number of patents per unit time based on unit time and the time information with respect to the patent group. The cumulative reference time point calculating unit 1360 calculates a cumulative reference time point with respect to the cumulative number of patents per unit time calculated by the cumulative patent number calculating unit 1350. The time score calculating unit 1370 calculates the time score based on the cumulative reference time point calculated by the cumulative reference time point calculating unit 1360.

The following Equation (4) is an example of a method for calculating a time score (TS).

TS=(n−k)/(n) Equation (4)

(TS: time score, n: entire period of time, and k: period of time until time point k)

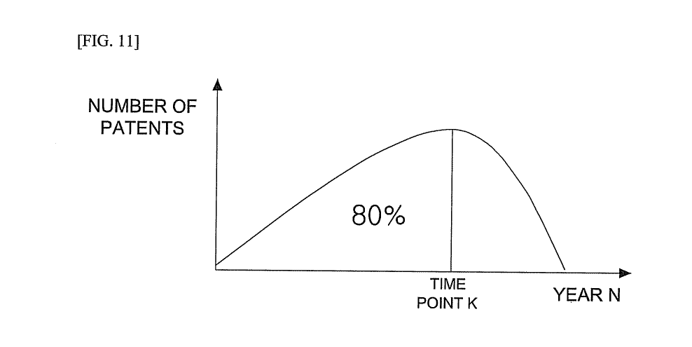

For example, the time point k may be set as a time point in which the cumulative number of patents is 80% of the total as shown in FIG. 11.

For the capability development of a convergence product, both a product launch time point and development types of the patents should be considered. Main patents with respect to the convergence product are generally registered before a corresponding product is launched, and when the product is launched, the number of registered patents is likely to be significantly reduced. Thus, an increase in the number of registered patents may denote an increase in the development potential of the corresponding capability and a reduction in the number of registered patents may denote a decline of the development potential. When the highest point (peak) of the number of patent applications associated with the convergence product occupies a specific position (for example, a position corresponding to 80%) of the total cumulative number of patents, the time score may be calculated as shown in Equation (4).

Finally, the capability development index calculating unit 1300 may calculate a capability development index based on the calculated capability score and time score.

The following Equation (5) is an example of a method for calculating a capability development index (CI1).

CI1=FS*AFS+TS*ATS Equation (5)

(CI1: capability development index, FS: capability score, AFS: distribution of capability score, TS: time score, and ATS: distribution of time score)

Referring again to FIG. 2, the capability convergence index calculating unit 1400 calculates a capability convergence index based on the patent classification acquired by the data processing unit 1200. Specifically, the capability convergence index calculating unit 1400 may calculate the capability convergence index using the capability convergence score and the service score which are calculated based on the patent classification.

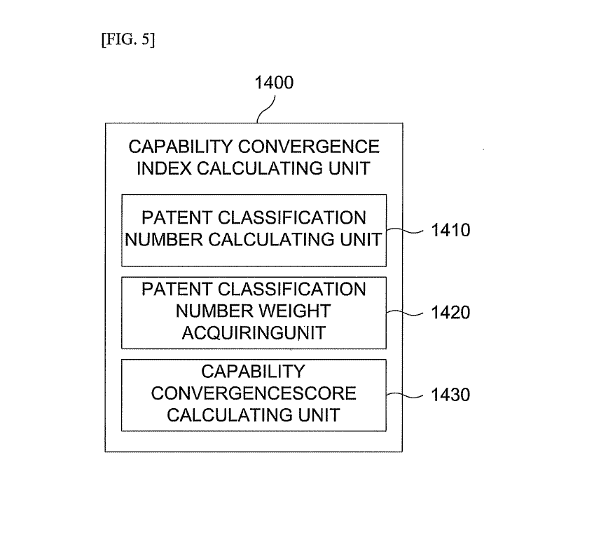

FIG. 5 is a diagram showing an example of a capability convergence index calculating unit for calculating a capability convergence score according to an embodiment of the present invention.

Referring to FIG. 5, the capability convergence index calculating unit 1400 may include a patent classification number calculating unit 1410, a patent classification number weight acquiring unit 1420, and a capability convergence score calculating unit 1430.

The patent classification number calculating unit 1410 calculates the number of patent classifications based on the number of at least one of the patent classifications related to the single patent.

The patent classification number weight acquiring unit 1420 acquires weights of the number of patent classifications corresponding to the number of patent classifications.

The capability convergence score calculating unit 1430 calculates the capability convergence score based on the number of patent classifications and the weights of the number of patent classifications.

The following Equation (6) is an example of a method for calculating a capability convergence score (FC).

FC=ACS*(WS/Σ(NCi))*1−exp(−Σ(NCi)/100)

(FC: capability convergence score, ACS: distribution of capability convergence score, Σ(NCi): sum of the number of patents in accordance with the number of patent classifications, WS=Σ(NCi*Wi): weighted sum of the number of patents in accordance with the number of patent classifications and the weights, NCi: the number of patents when the number of USPCs including patents is i or more, and Wi: weights when the number of USPCs including patents is i)

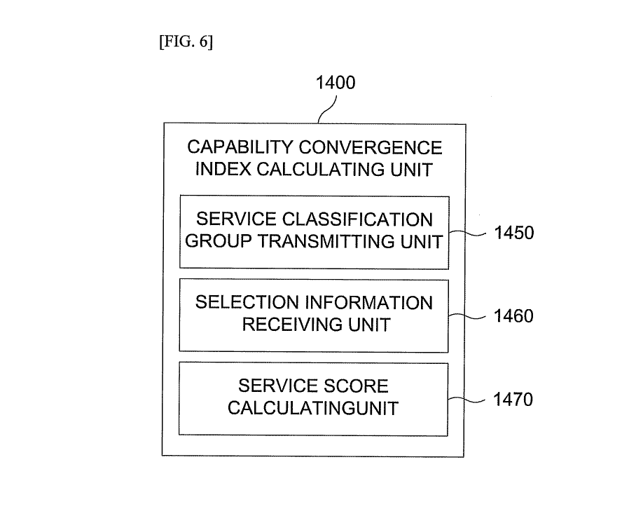

FIG. 6 is a diagram showing an example of a capability convergence index calculating unit 1400 for calculating a service score according to an embodiment of the present invention.

Referring to FIG. 6, the capability convergence index calculating unit 1400 may include a service classification group transmitting unit 1450, a selection information receiving unit 1460, and a service score calculating unit 1470.

The service classification group transmitting unit 1450 transmits a service classification group including at least two services to the user computer 2000.

The selection information receiving unit 1460 receives selection information including information about the service selected from the service classification group from the user computer 2000.

The service score calculating unit 1470 calculates the service score based on the selection information. Specifically, the service score calculating unit 1470 may calculate the service score based on the number of selected services with reference to the selection information. In this instance, the service score may be calculated using service weight information.

Referring again to FIG. 2, the industry relation index calculating unit 1500 calculates an industry relation index based on the patent classification and the industrial classification which are acquired by the data processing unit 1200. Specifically, the industry relation index calculating unit 1500 may calculate the industry relation index using a relation score of heterogeneous industries and a relation score of homogeneous industries which are calculated based on the patent classification and the industrial classification.

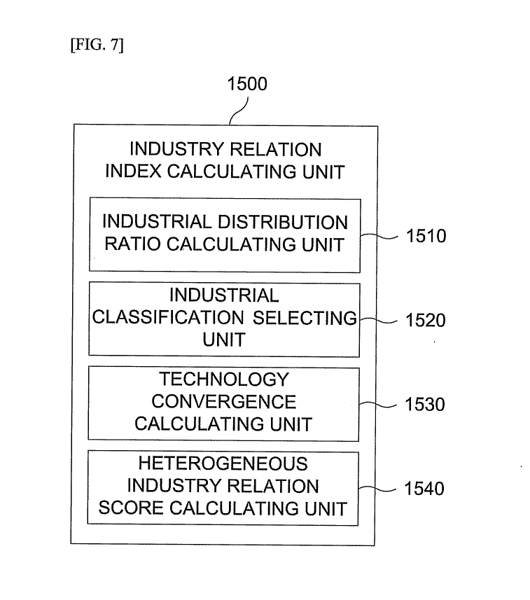

FIG. 7 is a diagram showing an example of an industry relation index calculating unit 1500 for calculating a relation score of heterogeneous industries according to an embodiment of the present invention.

Referring to FIG. 7, the industry relation index calculating unit 1500 may include an industrial distribution ratio calculating unit 1510, an industrial classification selecting unit 1520, a technology convergence calculating unit 1530, and a heterogeneous industry relation score calculating unit 1540.

The industrial distribution ratio calculating unit 1510 calculates an industrial distribution ratio based on the industrial classification. Specifically, the industrial classification is related to the patent classification in an industrial classification group such as SIC. The industrial distribution ratio may be calculated by dividing the number of industrial classifications by the total number of industrial classifications included in the industrial classification group. When the distribution ratio for each industry is high, the industry convergence potential is large, and when the related technologies are concentrated in a specific industry, the degree of technology convergence is high.

The industrial classification selecting unit 1520 selects at least two of the industrial classifications in the order of larger number of patents related to the industrial classification. In this instance, it is preferable that three industrial classifications are selected.

The technology convergence calculating unit 1530 calculates the degree of technology convergence based on the number of patents related to the industrial classification selected by the industrial classification selecting unit 1520. The degree of technology convergence may be calculated by dividing the number of patents related to the selected industrial classification by the total number of patents included in the patent group.

The heterogeneous industry relation score calculating unit 1540 calculates the relation score of heterogeneous industries based on the industrial distribution ratio and the degree of technology convergence. For example, the relation of the heterogeneous industries is proportional to the industrial distribution ratio, but inversely proportional to the degree of technology convergence, and therefore the industrial distribution ratio may be divided by the degree of technology convergence to be calculated.

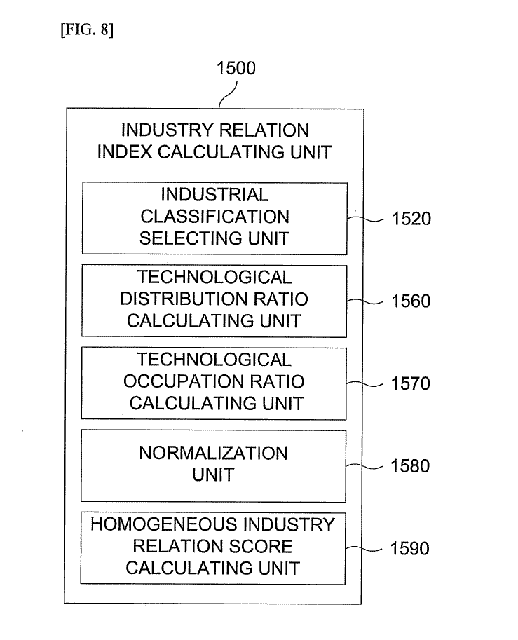

FIG. 8 is a diagram showing an example of an industry relation index calculating unit 1500 for calculating a relation score of homogeneous industries according to an embodiment of the present invention.

Referring to FIG. 8, the industry relation index calculating unit 1500 may include an industrial classification selecting unit 1520, a technological distribution ratio calculating unit 1560, a technological occupation ratio calculating unit 1570, and a homogeneous industry relation score calculating unit 1590. In addition, the industry relation index calculating unit 1500 may further include a normalization unit 1580.

The industrial classification selecting unit 1520 selects at least two of the industrial classifications in the order of larger number of patents related to the industrial classification.

The technological distribution ratio calculating unit 1560 calculates a technological distribution ratio based on the number of patents related to the industrial classification selected by the industrial classification selecting unit 1520. For example, the technological distribution ratio with respect to a first industrial classification may be calculated by dividing the number of patents related to a first corresponding industrial classification by the total number of patents included in the patent group.

The technological occupation ratio calculating unit 1570 calculates a technological occupation ratio based on the number of patent classifications including the patent related to the industrial classification selected by the industrial classification selecting unit 1520. For example, the technological occupation ratio may be calculated by dividing the number of patent classifications including the patent related to the industrial classification by the total number of patent classifications which can be related to the industrial classification.

The normalization unit 1580 normalizes the technological occupation ratio based on a correction coefficient of the technological occupation ratio.

The following Equation (7) is an example of a method for performing normalization processing on the technological occupation ratio.

NTSn=TSn*Kn Equation (7)

(NTSn: normalized technological occupation ratio, TSn: technological occupation ratio, and Kn: correction coefficient)

(Correction coefficient (Kn (n=2,3))=Kn−1* (sum of the number of middle classification patents of analysis set of Topn/sum of the number of patents for each middle classification patent of Top1)*TPn

Correction coefficient of first corresponding industrial classification K1=1

Correction coefficient of second corresponding industrial classification K2=K1*(the number of patent classifications including patents related to second corresponding industrial classification/the number of patent classifications that can be related to first corresponding industrial classification)*TP2

Correction coefficient of third corresponding industrial classification K3=K2*(the number of patent classifications including patents related to third corresponding industrial classification/the number of patent classifications that can be related to second corresponding industrial classification)*TP3)

In this instance, it is preferable that the correction coefficient be differently applied for each rank of corresponding industrial classifications.

The homogeneous industry relation score calculating unit 1590 calculates the relation score of homogeneous industries based on the technological distribution ratio and the technological occupation ratio. For example, the relation score of homogeneous industries may be calculated by dividing an average of the normalized technological occupation ratios by a sum of distribution ratios for each industry.

Referring again to FIG. 2, the system 1000 for servicing the convergence index according to an embodiment of the present invention may further include a data storage unit 1600. The data storage unit 1600 stores data required for calculating the convergence index such as the patent, the patent classification, and the industrial classification.

In addition, the system 1000 for servicing the convergence index according to an embodiment of the present invention may further include an auxiliary variables storage unit 1700. The auxiliary variables storage unit 1700 stores auxiliary variables required for calculating the capability development index, the capability convergence index, and the industry relation index. Specifically, the auxiliary variables storage unit 1700 may manage various time processing units for calculating the convergence index, a type or a depth of used patent classification, a parameter or a weight with respect to various scores, a distribution policy, and the like.

In addition, the system 1000 for servicing the convergence index according to an embodiment of the present invention may further include a convergence index servicing unit 1800.

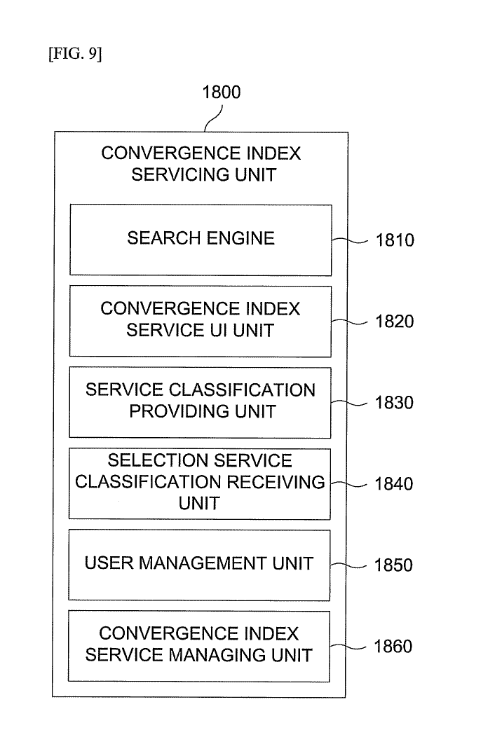

FIG. 9 is a diagram showing an example of a convergence index servicing unit 1800 according to an embodiment of the present invention.

Referring to FIG. 9, the convergence index servicing unit 1800 according to an embodiment of the present invention may include at least one of a search engine, a convergence index service user interface (UI) unit 1820, a service classification providing unit 1830, a selection service classification receiving unit 1840, a user management unit 1850, and a convergence index service managing unit 1860. The search engine supports search for the patent. The convergence index service UI unit 1820 provides an UI for providing all services about a convergence index to a user. The service classification providing unit 1830 transmits service classification data to the user computer 2000. The selection service classification receiving unit 1840 receives a service classification selected by the user. The user management unit 1850 stores data related to the user. The convergence index service managing unit 1860 processes charging information, provides web services to a plurality of users or a plurality of systems, and provides various supplementary services.

### INDUSTRIAL APPLICABILITY

The present invention may be applied to measurement of the degree of convergence, estimation of convergence properties, calculation of convergence index, and services using these with respect to products or technologies or the related patent group.

In addition, the present invention may be used in systematically promoting convergence industry development.

Although a few embodiments of the present invention have been shown and described, it would be appreciated by those skilled in the art that changes may be made in this embodiment without departing from the principles and spirit of the invention, the scope of which is defined in the claims and their equivalents.

1. A convergence index service system for providing a convergence index to a user computer through a wired network or a wireless network, the system comprising:
a patent group receiving unit configured to receive a patent group including at least two patents from the user computer;
a data processing unit configured to acquire time information, a patent classification and an industrial classification corresponding to the patent classification related to each of the at least two patents in the patent group;
a capability development index calculating unit configured to calculate a capability development index based on the time information and the patent classification acquired by the data processing unit;
a capability convergence index calculating unit configured to calculate a capability convergence index based on the patent classification acquired by the data processing unit; and
an industry relation index calculating unit configured to calculate an industry relation index based on the patent classification and the industrial classification acquired by the data processing unit,
wherein the industry relation index calculating unit calculates the industry relation index using a relation score of heterogeneous industries and a relation score of homogeneous industries calculated based on the patent classification and the industrial classification.

2. The system of claim 1, wherein the industry relation index calculating unit includes:
an industrial distribution ratio calculating unit configured to calculate an industrial distribution ratio based on the industrial classification;
an industrial classification selecting unit configured to select at least two of the industrial classification according to number of patents related to the industrial classification;
a technology convergence calculating unit configured to calculate the degree of technology convergence based on the number of patents related to the industrial classification selected by the industrial classification selecting unit; and
a heterogeneous industry relation score calculating unit configured to calculate the relation score of heterogeneous industries based on the industrial distribution ratio and the degree of technology convergence.

3. The system of claim 1, wherein the industry relation index calculating unit includes:
an industrial classification selecting unit configured to select at least two of the industrial classification according to number of patents related to the industrial classification;
a technological distribution ratio calculating unit configured to calculate a technological distribution ratio based on the number of patents related to the industrial classification selected by the industrial classification selecting unit;
a technological occupation ratio calculating unit configured to calculate a technological occupation ratio based on number of patent classification including the patent related to the industrial classification selected by the industrial classification selecting unit; and
a homogeneous industry relation score calculating unit configured to calculate the relation score of homogeneous industries based on the technological distribution ratio and the technological occupation ratio.

4. The system of claim 3, wherein the technological occupation ratio calculating unit includes a normalization unit configured to normalize the technological occupation ratio based on a correction coefficient of the technological occupation ratio.

5. The system of claim 1, wherein the capability development index calculating unit calculates the capability development index using a capability score and a time score calculated based on the time information and the patent classification.

6. The system of claim 5, wherein the capability development index calculating unit includes:
a patent number calculating unit configured to calculate number of patents per unit time with respect to the patent group based on unit time and the time information
a new technology-related patent number calculating unit configured to calculate number of new technology-related patents per unit time based on the patent classification and unit time; and
a capability score calculating unit configured to calculate the capability score based on the number of patents per unit time and the number of new technology-related patents per unit time.

7. The system of claim 5, wherein the capability development index calculating unit includes:
a cumulative patent number calculating unit configured to calculate cumulative number of patents per unit time for the patent group based on unit time and the time information;
a cumulative reference time point calculating unit configured to calculate a cumulative reference time point related to the cumulative number of patents per unit time; and
a time score calculating unit configured to calculate the time score based on the cumulative reference time point.

8. The system of claim 1, wherein the capability convergence index calculating unit calculates the capability convergence index using a capability convergence score and a service score calculated based on the patent classification.

9. The system of claim 8, wherein the capability convergence index calculating unit includes:
a patent classification number calculating unit configured to calculate number of patent classification based on number of at least one patent classification related to a single patent;
a patent classification number weight acquiring unit configured to acquire weights of the number of patent classification corresponding to the number of patent classification; and
a capability convergence score calculating unit configured to calculate the capability convergence score based on the number of patent classification and the weights of the number of patent classification.

10. The system of claim 8, wherein the capability convergence index calculating unit includes:
a service classification group transmitting unit configured to transmit a service classification group including at least two services to the user computer;
a selection information receiving unit configured to receive selection information including information on the service selected from the service classification group from the user computer; and
a service score calculating unit configured to calculate the service score based on the selection information.

11. The system of claim 1, wherein the patent classification is determined according to a predetermined depth in a patent classification system including the patent classification.

12. The system of claim 11, wherein the capability development index is calculated based on a main patent classification of the patent classification, the capability convergence index is calculated based on a sub patent classification and the main patent classification, and the industry relation index is calculated based on the main patent classification.

13. The system of claim 1, further comprising:
a data storage unit configured to store the patent, the patent classification and the industrial classification.

14. The system of claim 1, further comprising:
an auxiliary variables storage unit configured to store auxiliary variables required for calculating the capability development index, the capability convergence index and the industry relation index.
